(19) United States
(12) Patent Application Publication
(10) Pub. No.: US 2013/0201107 A1
(43) Pub. Date: Aug. 8, 2013

(54) Simulating Input Types

(71) Applicants: Jacob S. Rossi, Seattle, WA (US); Justin E. Rogers, Redmond, WA (US); Nathan J.E. Furtwangler, Seattle, WA (US)

(72) Inventors: Jacob S. Rossi, Seattle, WA (US); Justin E. Rogers, Redmond, WA (US); Nathan J.E. Furtwangler, Seattle, WA (US)

(73) Assignee: Microsoft Corporation, Redmond, WA (US)

(21) Appl. No.: 13/368,652

(22) Filed: Feb. 8, 2012

(51) Int. Cl. G06F 3/041; G06F 3/033; G06F 3/00

(52) U.S. Cl. 345/163; 345/156; 345/173

(57) ABSTRACT

A timer is utilized in an input simulation process that simulates an input of one type when an input of a different type is received. In at least some embodiments, when a first type of input is received, a corresponding timer is started. If, before passage of an associated time period, a first input scenario is present, then one or more actions associated with the first input type are performed. If, on the other hand, after passage of the associated time period, a second input scenario is present, then one or more actions associated with a second input type are performed by using the first input type to simulate the second input type.

### BACKGROUND

In some instances, computing system interactions that are supported for one input type may not necessarily be supported, in the same way, for a different input type. As an example, consider inputs that are received from a mouse and inputs that are received through touch.

In mouse input scenarios, a mouse can be used to point to a particular element on the display screen without necessarily activating the element. In this instance, a mouse can be said to “hover” over the element. Many websites rely on the ability of a pointing device, such as a mouse, to “hover” in order to support various user interface constructs. One such construct is an expandable menu. For example, an expandable menu may open when a user hovers the mouse over the element without necessarily activating the element. Activating the element (as by clicking on the element), on the other hand, may result in a different action such as a navigation to another webpage.

With touch inputs, however, the same user interaction that is utilized to hover an element is used to activate it (i.e. tapping). Thus, tapping an element will both hover and activate it. Accordingly, portions of websites may be inaccessible to users of touch. Specifically, in touch scenarios, there may be no way to open the menu without activating the associated element.

This specific example underscores a more general scenario in which some input types are not necessarily supported in some systems.

### SUMMARY

This Summary is provided to introduce a selection of concepts in a simplified form that are further described below in the Detailed Description. This Summary is not intended to identify key features or essential features of the claimed subject matter.

In one or more embodiments, a timer is utilized in an input simulation process that simulates an input of one type when an input of a different type is received.

In at least some embodiments, when a first type of input is received, a corresponding timer is started. If, before passage of an associated time period, a first input scenario is present, then one or more actions associated with the first input type are performed. If, on the other hand, after passage of the associated time period, a second input scenario is present, then one or more actions associated with a second input type are performed by using the first input type to simulate the second input type.

In at least some other embodiments, when a touch input is received, a corresponding timer is started. If, before passage of an associated time period, the touch input is removed, actions associated with the touch input are performed, e.g., actions associated with a tap input or, actions that are mapped to a mouse input such as an activation or “click”. If, on the other hand, after passage of the associated time, the touch input is removed, actions associated with a mouse input are performed by using the touch input to simulate the mouse input.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation in accordance with one or more embodiments.

FIG. 2 is an illustration of a system in an example implementation showing FIG. 1 in greater detail.

FIG. 3 is a flow diagram that describes steps of a method in accordance with one or more embodiments.

FIG. 4 is a flow diagram that describes steps of a method in accordance with one or more embodiments.

FIG. 5 is a diagrammatic representation of an implementation example in accordance with one or more embodiments.

FIG. 6 illustrates an example computing device that can be utilized to implement various embodiments described herein.

### DETAILED DESCRIPTION

Overview

In one or more embodiments, a timer is utilized in an input simulation process that simulates an input of one type when an input of a different type is received.

In at least some embodiments, when a first type of input is received, a corresponding timer is started. If, before passage of an associated time period, a first input scenario is present, then one or more actions associated with the first input type are performed. If, on the other hand, after passage of the associated time period, a second input scenario is present, then one or more actions associated with a second input type are performed by using the first input type to simulate the second input type.

In at least some other embodiments, when a touch input is received, a corresponding timer is started. If, before passage of an associated time period, the touch input is removed, actions associated with the touch input are performed, e.g., actions associated with a tap input or, actions that are mapped to a mouse input such as an activation or “click”. If, on the other hand, after passage of the associated time, the touch input is removed, actions associated with a mouse input are performed by using the touch input to simulate the mouse input, e.g., actions associated with a hover.

In the following discussion, an example environment is first described that is operable to employ the techniques described herein. Example illustrations of the various embodiments are then described, which may be employed in the example environment, as well as in other environments. Accordingly, the example environment is not limited to performing the described embodiments and the described embodiments are not limited to implementation in the example environment.

Example Operating Environment

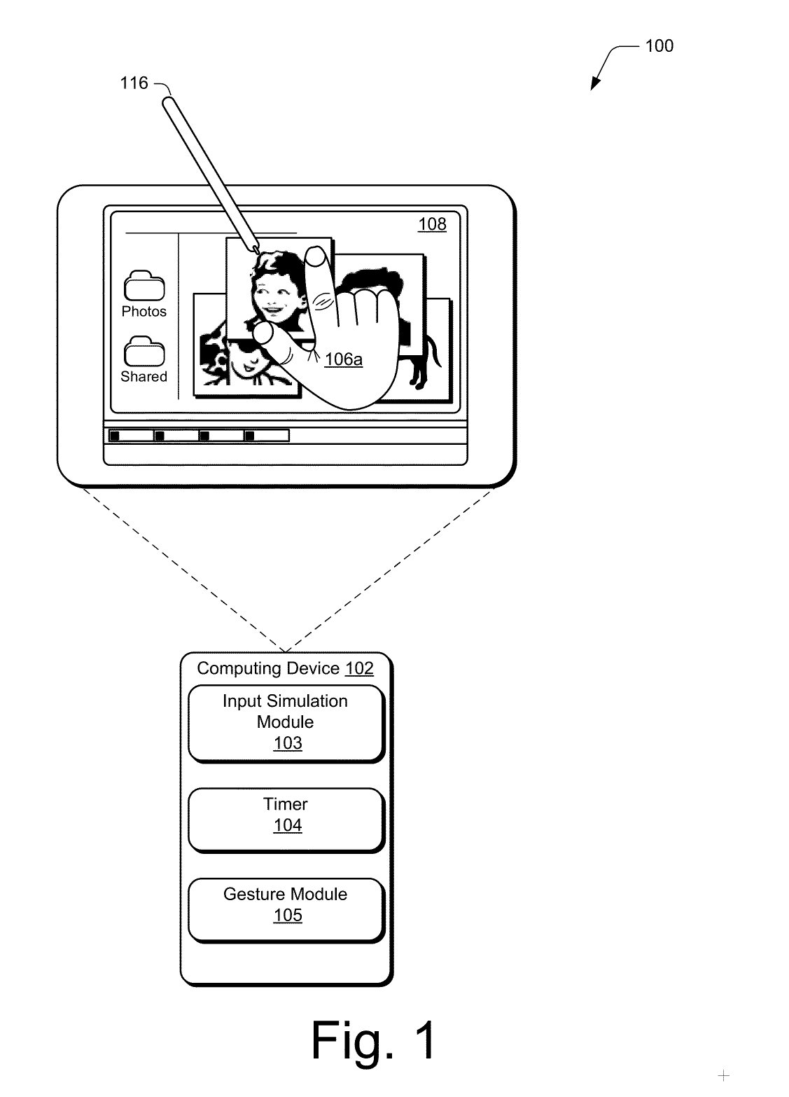

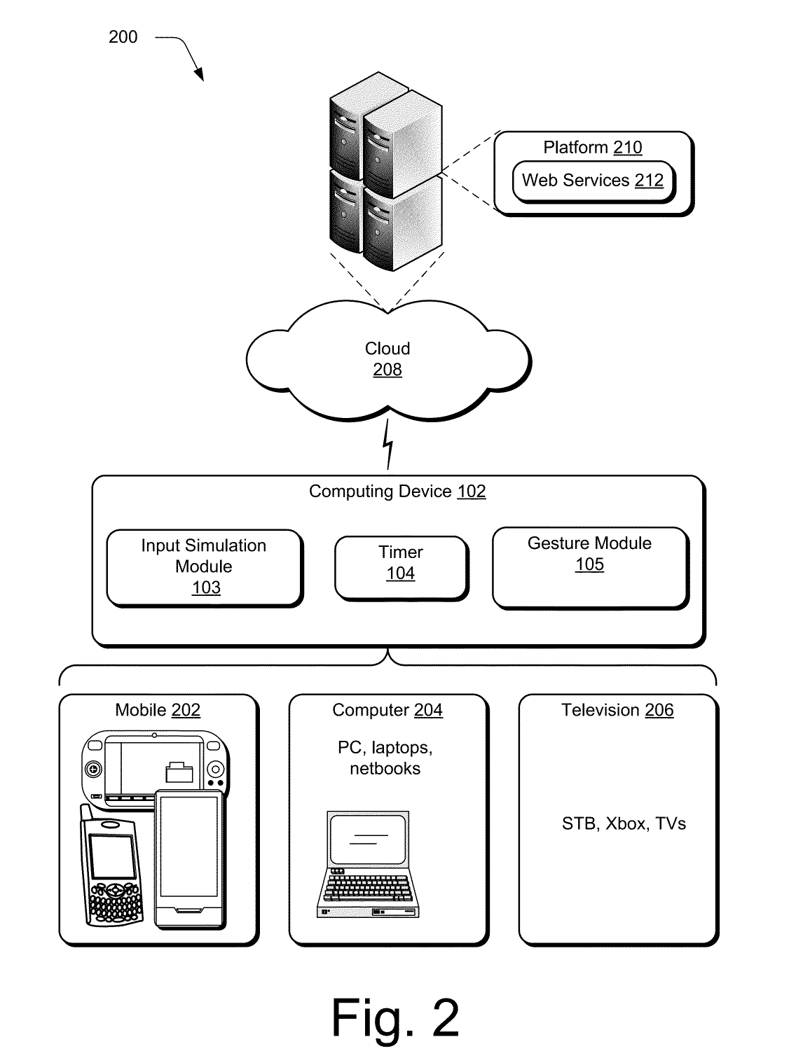

FIG. 1 is an illustration of an environment 100 in an example implementation that is operable to employ the techniques described in this document. The illustrated environment 100 includes an example of a computing device 102 that may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, a handheld device, and so forth as further described in relation to FIG. 2. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 also includes software that causes the computing device 102 to perform one or more operations as described below.

Computing device 102 includes an input simulation module 103, a timer 104, and a gesture module 105.

In one or more embodiments, the input simulation module 103, timer 104, and gesture module 105 work in concert to implement an input simulation process that simulates an input of one type when an input of a different type is received. The inventive embodiments can be utilized in connection with any suitable type of application. In the examples described below, such application resides in the form of a web browser. It is to be appreciated and understood, however, that other applications can utilize the techniques described herein without departing from the spirit and scope of the claimed subject matter.

In at least some embodiments, when an input is received by, for example, gesture module 105, a corresponding timer 104 is started. If, before passage of an associated time period, a first input scenario is present, then one or more actions associated with a first input type are performed under the influence of the input simulation module 103. If, on the other hand, after passage of the associated time period, a second input scenario is present, then one or more actions associated with a second input type are simulated under the influence of the input simulation module 103.

In at least some embodiments, the inputs that are subject to the input simulation process are touch inputs and mouse inputs. That is, in the scenarios described below, input that is received via touch can be utilized to simulate mouse inputs sufficient to cause actions associated with the simulated mouse inputs to be performed. Specifically, in one example, when a touch input is received, a corresponding timer, such as timer 104 is started. If, before passage of an associated time period, the touch input is removed, actions associated with the touch input are performed, e.g., actions associated with a tap input. These actions can be facilitated by dispatching certain script events to facilitate performance of the actions. If, on the other hand, after passage of the associated time, the touch input is removed, actions associated with a simulated mouse input are performed, e.g. actions associated with a hover. Again, these actions can be facilitated by dispatching certain script events and, in addition, omitting the dispatch of other script events, as will become apparent below.

The gesture module 105 recognizes input pointer gestures that can be performed by one or more fingers, and causes operations or actions to be performed that correspond to the gestures. The gestures may be recognized by module 105 in a variety of different ways. For example, the gesture module 105 may be configured to recognize a touch input, such as a finger of a user's hand 106a as proximal to display device 108 of the computing device 102 using touchscreen functionality, or functionality that senses proximity of a user's finger that may not necessarily be physically touching the display device 108, e.g., using near field technology. Module 105 can be utilized to recognize single-finger gestures and bezel gestures, multiple-finger/same-hand gestures and bezel gestures, and/or multiple-finger/different-hand gestures and bezel gestures. Although the input simulation module 103, timer 104 and gesture module 105 are depicted as separate modules, the functionality provided by these modules can be implemented in a single, integrated gesture module. The functionality implemented by these modules can be implemented by any suitably configured application such as, by way of example and not limitation, a web browser. Other applications can be utilized without departing from the spirit and scope of the claimed subject matter, as noted above.

The computing device 102 may also be configured to detect and differentiate between a touch input (e.g., provided by one or more fingers of the user's hand 106a) and a stylus input (e.g., provided by a stylus 116). The differentiation may be performed in a variety of ways, such as by detecting an amount of the display device 108 that is contacted by the finger of the user's hand 106a versus an amount of the display device 108 that is contacted by the stylus 116.

Thus, the gesture module 105 may support a variety of different gesture techniques through recognition and leverage of a division between stylus and touch inputs, as well as different types of touch inputs and non-touch inputs.

FIG. 2 illustrates an example system 200 showing the input simulation module 103, timer 104 and gesture module 105 as being implemented in an environment where multiple devices are interconnected through a central computing device. The central computing device may be local to the multiple devices or may be located remotely from the multiple devices. In one embodiment, the central computing device is a “cloud” server farm, which comprises one or more server computers that are connected to the multiple devices through a network or the Internet or other means.

In one embodiment, this interconnection architecture enables functionality to be delivered across multiple devices to provide a common and seamless experience to the user of the multiple devices. Each of the multiple devices may have different physical requirements and capabilities, and the central computing device uses a platform to enable the delivery of an experience to the device that is both tailored to the device and yet common to all devices. In one embodiment, a “class” of target device is created and experiences are tailored to the generic class of devices. A class of device may be defined by physical features or usage or other common characteristics of the devices. For example, as previously described the computing device 102 may be configured in a variety of different ways, such as for mobile 202, computer 204, and television 206 uses. Each of these configurations has a generally corresponding screen size and thus the computing device 102 may be configured as one of these device classes in this example system 200. For instance, the computing device 102 may assume the mobile 202 class of device which includes mobile telephones, music players, game devices, and so on. The computing device 102 may also assume a computer 204 class of device that includes personal computers, laptop computers, netbooks, and so on. The television 206 configuration includes configurations of device that involve display in a casual environment, e.g., televisions, set-top boxes, game consoles, and so on. Thus, the techniques described herein may be supported by these various configurations of the computing device 102 and are not limited to the specific examples described in the following sections.

Cloud 208 is illustrated as including a platform 210 for web services 212. The platform 210 abstracts underlying functionality of hardware (e.g., servers) and software resources of the cloud 208 and thus may act as a “cloud operating system.” For example, the platform 210 may abstract resources to connect the computing device 102 with other computing devices. The platform 210 may also serve to abstract scaling of resources to provide a corresponding level of scale to encountered demand for the web services 212 that are implemented via the platform 210. A variety of other examples are also contemplated, such as load balancing of servers in a server farm, protection against malicious parties (e.g., spam, viruses, and other malware), and so on.

Thus, the cloud 208 is included as a part of the strategy that pertains to software and hardware resources that are made available to the computing device 102 via the Internet or other networks.

The gesture techniques supported by the input simulation module 103 and gesture module 105 may be detected using touchscreen functionality in the mobile configuration 202, track pad functionality of the computer 204 configuration, detected by a camera as part of support of a natural user interface (NUI) that does not involve contact with a specific input device, and so on. Further, performance of the operations to detect and recognize the inputs to identify a particular gesture may be distributed throughout the system 200, such as by the computing device 102 and/or the web services 212 supported by the platform 210 of the cloud 208.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on or by a processor (e.g., CPU or CPUs). The program code can be stored in one or more computer readable memory devices. The features of the gesture techniques described below are platform-independent, meaning that the techniques may be implemented on a variety of commercial computing platforms having a variety of processors.

In the discussion that follows, various sections describe various example embodiments. A section entitled “Simulating Input Types—Example” describes embodiments in which input types can be simulated. Next, a section entitled “Implementation Example” describes an example implementation in accordance with one or more embodiments. Last, a section entitled “Example Device” describes aspects of an example device that can be utilized to implement one or more embodiments.

Having described example operating environments in which the input simulation functionality can be utilized, consider now a discussion of an example embodiments.

Simulating Input Types—Example

As noted above, in one or more embodiments, a timer is utilized in an input simulation process that simulates an input of one type when an input of a different type is received.

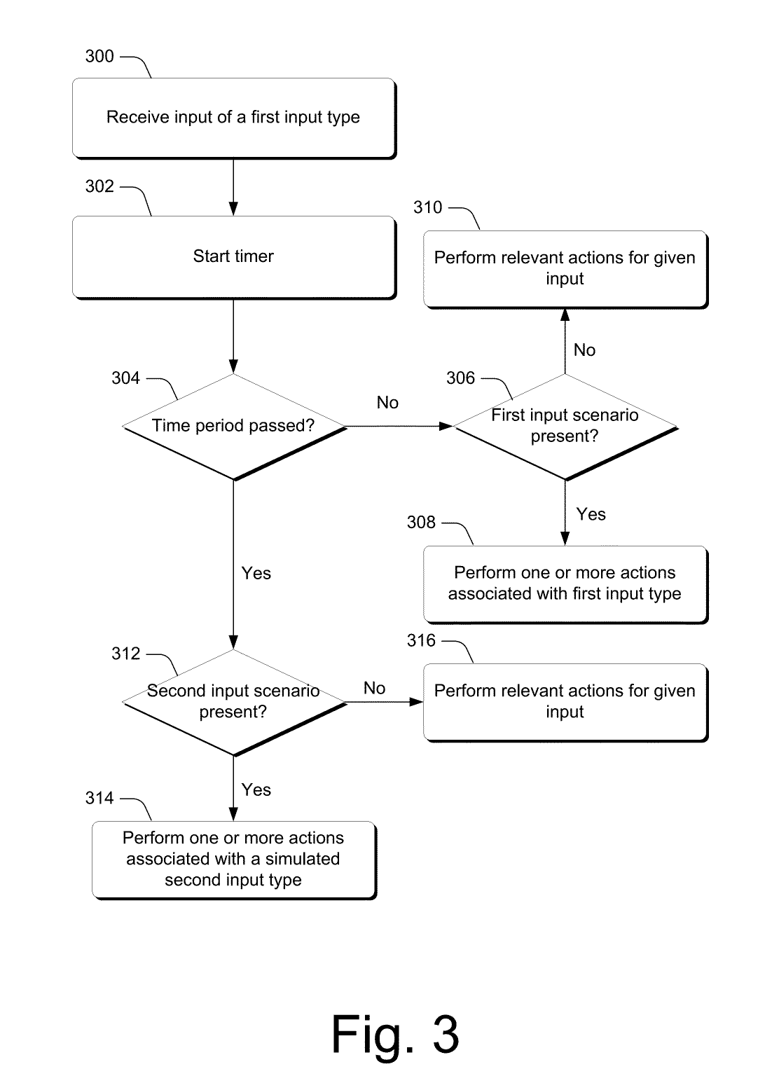

FIG. 3 is a flow diagram that describes steps in an input simulation process or method accordance with one or more embodiments. The method can be performed in connection with any suitable hardware, software, firmware, or combination thereof. In at least some embodiments, the method can be performed by software in the form of computer readable instructions, embodied on some type of computer-readable storage medium, which can be performed under the influence of one or more processors. Examples of software that can perform the functionality about to be described are the input simulation module 103, timer 104 and the gesture module 105 described above.

Step 300 receives input of a first input type. Any suitable type of input can be received, examples of which are provided above and below. Step 302 starts a timer. Step 304 ascertains whether a time period has passed. Any suitable time period can be utilized, examples of which are provided below. If the time period has not passed, step 306 ascertains whether a first input scenario is present. Any suitable type of input scenario can be utilized. For example, in at least some embodiments, an input scenario may be defined by detecting removal of the input. Other input scenarios can be utilized without departing from the spirit and scope of the claimed subject matter.

If the first input scenario is present, step 308 performs one or more actions associated with the first input type. Any suitable type of actions can be performed. If, on the other hand, step 306 ascertains that the first input scenario is not present, step 310 performs relevant actions for a given input. This step can be performed in any suitable way. For example, in the embodiments where the first input scenario constitutes detecting removal of the input, if the input remains (i.e. the “no” branch), this step can be performed by returning to step 304 to ascertain whether the time period has passed. In this example, the timer can continue to be monitored for the passage of the time period.

If, on the other hand, step 304 ascertains that the time period has passed, step 312 ascertains whether a second input scenario is present. Any suitable type of second input scenario can be utilized. For example, in at least some embodiments, a second input scenario may be defined by detecting removal of the input. If the second input scenario is present, step 314 performs one or more actions associated with a simulated second input type. In one or more embodiments, the second input type is different than the first input type. Any suitable actions can be performed. If, on the other hand, the second input scenario is not present after the time period has passed, step 316 performs relevant actions for a given input. Any suitable type of relevant actions can be performed including, for example, no actions at all. Alternately or additionally, relevant actions can constitute those that are gesturally defined for the input that has been received after passage of the time period in the absence of the second input scenario.

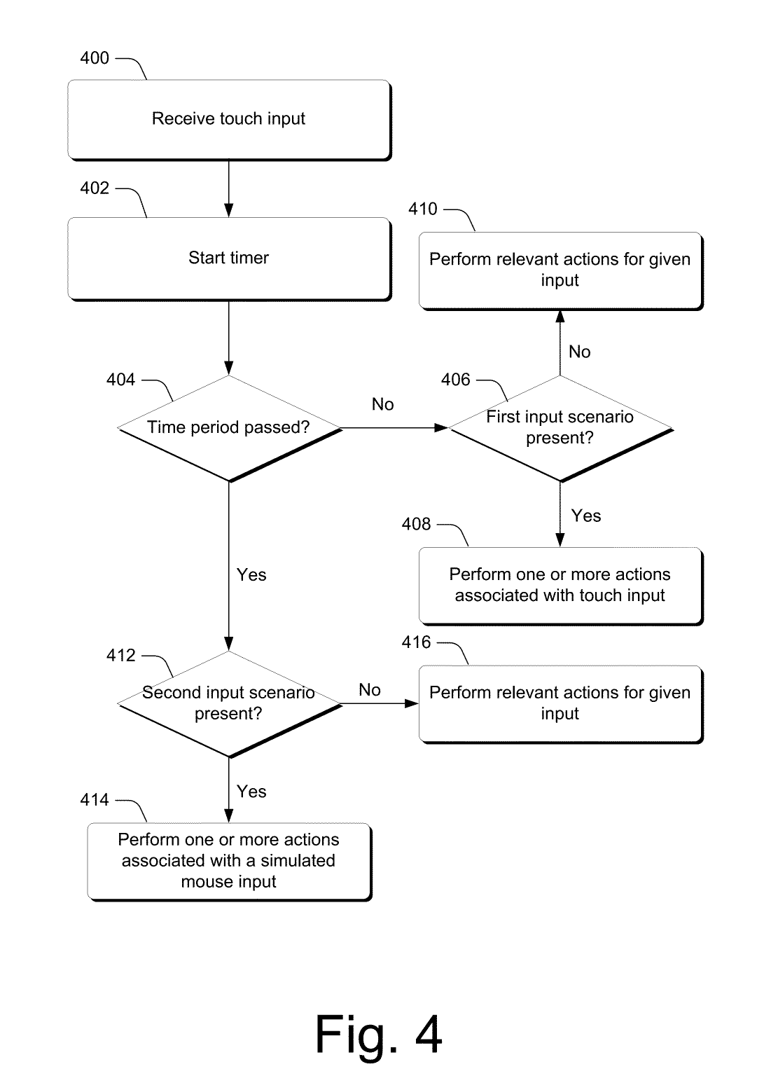

FIG. 4 is a flow diagram that describes steps in an input simulation process or method accordance with one or more other embodiments. The method can be performed in connection with any suitable hardware, software, firmware, or combination thereof. In at least some embodiments, the method can be performed by software in the form of computer readable instructions, embodied on some type of computer-readable storage medium, which can be performed under the influence of one or more processors. Examples of software that can perform the functionality about to be described are the input simulation module 103, timer 104 and the gesture module 105 described above.

Step 400 receives a touch input. This step can be performed in any suitable way. For example, the touch input can be received relative to an element that appears on a display device. Any suitable type of element can be the subject of the touch input. Step 402 starts a timer. Step 404 ascertains whether a time period has passed. Any suitable time period can be utilized, examples of which are provided below. If the time period has not passed, step 406 ascertains whether a first input scenario is present. Any suitable type of input scenario can be utilized. For example, in at least some embodiments, an input scenario may be defined by detecting removal of the touch input. Other input scenarios can be utilized without departing from the spirit and scope of the claimed subject matter. If the first input scenario is present, step 408 performs one or more actions associated with the touch input. Such actions can include, by way of example and not limitation, actions associated with a “tap”. If, on the other hand, step 406 ascertains that the first input scenario is not present, step 410 performs relevant actions for a given input. This step can be performed in any suitable way. For example, in the embodiments where the first input scenario constitutes detecting removal of the touch input, if the input remains (i.e. the “no” branch), this step can be performed by returning to step 404 to ascertain whether the time period has passed. In this example, the timer can continue to be monitored for the passage of the time period.

If, on the other hand, step 404 ascertains that the time period has passed, step 412 ascertains whether a second input scenario is present. Any suitable type of second input scenario can be utilized. For example, in at least some embodiments, a second input scenario may be defined by detecting removal of the touch input. If the second input scenario is present, step 414 performs one or more actions associated with a simulated mouse input. Any suitable actions can be performed such as, by way of example and not limitation, applying or continuing to apply one or more Cascading Style Sheets (CSS) styles defined by one or more pseudo-classes, dispatching certain events and omitting other events, as will become apparent below. Two example CSS pseudo-classes are the :hover pseudo-class and the :active pseudo-class. It is to be appreciated and understood, however, that such CSS pseudo-classes constitutes but two examples that can be the subject of the described embodiments. The CSS :hover pseudo-class on a selector allows formats to be applied to any of the elements selected by the selector that are being hovered (pointed at).

If, on the other hand, the second input scenario is not present after the time period has passed, step 416 performs relevant actions for a given input. Any suitable type of relevant actions can be performed including, for example, no actions at all. Alternately or additionally, relevant actions can constitute those that are gesturally defined for the input that has been received after passage of the time period in the absence of the second input scenario. For example, such actions can include actions associated with a “press and hold” gesture.

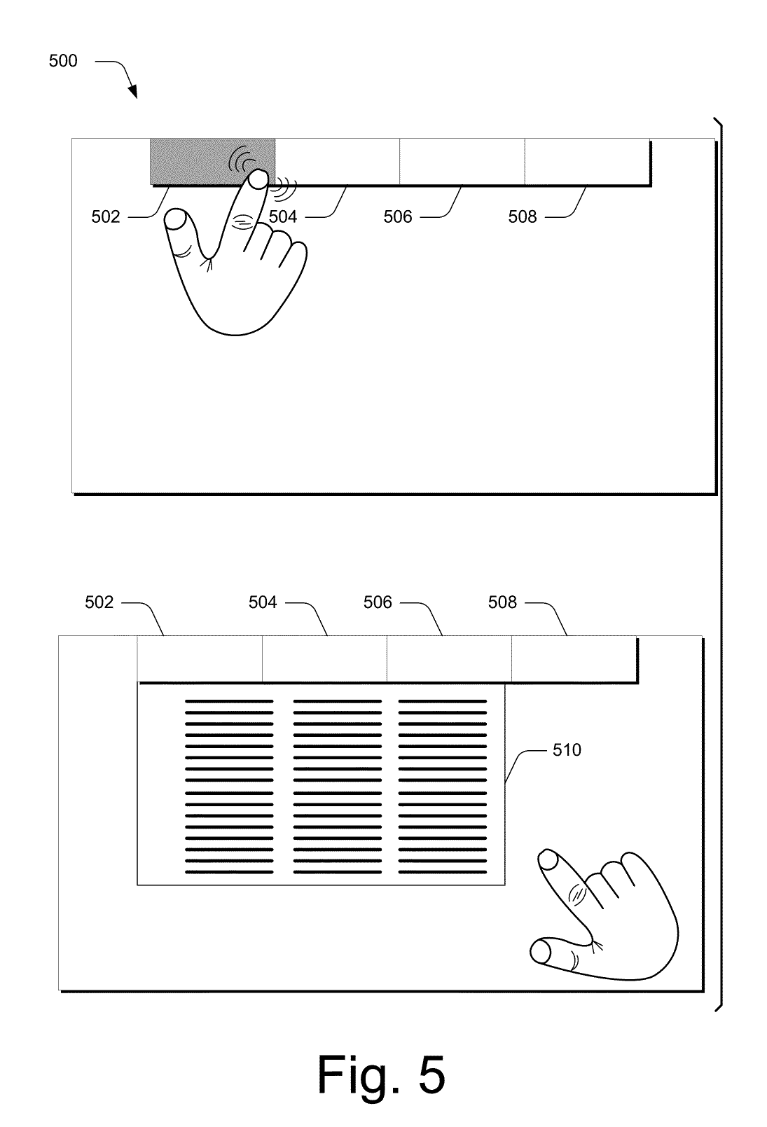

As an illustrative example of the above-described method, consider FIG. 5. There, an example webpage is represented generally at 500. The webpage 500 includes a number of activatable elements at 502, 504, 506, and 508. The activatable elements represent items that might appear at the top of the webpage.

Assume that a user touch-selects element 502, as indicated in the top most illustration of webpage 500. Once the touch input is received over element 502, a timer is started and the CSS :hover and :active styles that have been defined for element 502 can be applied immediately. In this particular example, the hover style results in a color change to element 502 as indicated. If, after a period of time, e.g., a pre-defined time or a dynamically selectable time has passed, the touch input is removed from element 502, as in the bottommost illustration of webpage 500 and another element has not been selected, the CSS :hover and :active styles that were previously applied can be persisted and one or more actions associated with a mouse input can be performed. In this particular example, the actions are associated with a mouse hover event which causes a menu region 510, associated with element 502, to be displayed. Had the user removed the touch input within the period of time, as by tapping element 502, a navigation to an associated webpage would have been performed.

In the illustrated and described embodiment, any suitable time period, e.g., a pre-defined time, can be utilized. In at least some embodiments, a pre-defined time period of 300 ms can be applied. This is so because studies have shown that almost all taps are less than 300 ms in duration.

Having considered example methods in accordance with one or more embodiments, consider now an implementation example that constitutes but one way in which the above-described functionality can be implemented.

Implementation Example

The following implementation example describes how a timer can be utilized to simulate mouse inputs in the presence of touch inputs. In this manner, in at least some embodiments, systems that are designed primarily for mouse inputs can be utilized with touch inputs to provide the same functionality as if mouse inputs were used. It is to be appreciated and understood, however, that touch inputs and mouse inputs, as such are described below, constitute but two input types that can utilize the techniques described herein. Accordingly, other input types can utilize the described techniques without departing from the spirit and scope of the claimed subject matter.

In this example, let “Duration” (i.e., the time period defined by the timer referenced above) be a time of less than 1 second, but more than 100 milliseconds. In at least some embodiments, the Duration can be calibrated by the implementer to improve the qualities of the interaction, such as user consistency and compensation for device quality. For example, the Duration may be lengthened for users that typically take longer to tap on an element when activating (e.g., users with medical conditions such as arthritis) or the Duration may be shortened for computing devices that can render formats for the CSS active/hover pseudo classes in a faster than average manner (which means the user sees a visual response to their contact much faster and is therefore likely to remove the contact at a faster pace when tapping).

Let a “Qualifying Element” be any node in an application's object model that will perform an action in response to being activated (e.g., “clicked”). For example, in an HTML-based application, a Qualifying Element may be a link. In an HTML-based application, the definition of a Qualifying Element can be extended to include any element that has “listeners” to activation script events, such as click or, in at least some scenarios, DOMActivate.

In at least some embodiments, the definition of a Qualifying Element may also be restricted by the implementer to only include activatable elements that are a part of a group of activatable elements (e.g., a navigational menu with multiple links). For example, in an HTML-based application, this restriction can be defined by limiting Qualifying Elements to those that are descendants of a list item.

In the following description, four different touch-based scenarios are described. A “Persistent Hover” state refers to a hover state that is simulated for a touch input to represent a mouse hover state, as will become apparent below.

In a first scenario, when the user contacts a Qualifying Element using touch, a timer is started for this element. If another element in the application that is not an ancestor or descendent of this element in an associated Document Object Model (DOM) tree is in the Persisted Hover state, then the following for actions are performed. Script events are dispatched that signal that the pointing device is no longer over the other element (e.g. mouseout, mouseleave). The application's formats resulting from the removal of the CSS :hover and :active pseudo classes from the other element are applied. The dispatch of script events that signal the activation of the other element (e.g. click, DOMActivate) are omitted. Last, performance of any default actions the application may have for activation of the other element (e.g., link navigation) are omitted.

Assuming that another element in the application that is not an ancestor or descendent of the contacted Qualifying Element is not in the Persistent Hover state, the following actions are performed. Script events that signal the pointing device is over the element (e.g., mouseover, mouseenter) are dispatched. Script events that signal the pointing device is in contact (“down”) with the element (e.g., mousedown) are dispatched. The application's formats resulting from the application of the CSS :hover and :active pseudo classes are applied to the element.

In a second scenario, if the user's contact is not removed from the device but is no longer positioned over the element, then the timer for this element is stopped and reset, and processing proceeds with the application or browser's default interaction experience.

In a third scenario, if the user's contact is lifted from the element and the timer has elapsed less than the Duration, then the following actions are performed. The timer for this element is stopped and reset. Script events that signal the pointing device is no longer over the element (e.g. mouseout, mouseleave) are dispatched. Further, script events that signal the pointing device is no longer in contact with the element (e.g., mouseup) are dispatched. The application's formats resulting from the removal of the CSS :hover and :active pseudo classes from the element are applied. Script events that signal the activation of the element (e.g. click, DOMActivate) are dispatched, and any default actions the application or browser may have for activation of the element (e.g., link navigation) are performed.

In a fourth scenario, if the user's contact is removed from the element, and the timer has elapsed more than Duration, then the following actions are performed. The timer for this element is stopped and reset. Script events that signal the pointing device is no longer in contact with the element (e.g., mouseup) are dispatched. The dispatch of script events that signal the pointing device is no longer over the element (e.g. mouseout, mouseleave) are omitted. The application's formats that resulted from the application of the CSS :hover and :active pseudo classes to the element in the first scenario are persisted. The dispatch of script events that signal the activation of the element (e.g. click, DOMActivate) are omitted. Any default actions the application or browser may have for activation of the element (e.g., link navigation) are not performed. Accordingly, this element, and its children, are considered to be in the “Persisted Hover” state.

Having considered an implementation example, consider now an example device that can be utilized to implement one or more embodiments as described above.

Example Device

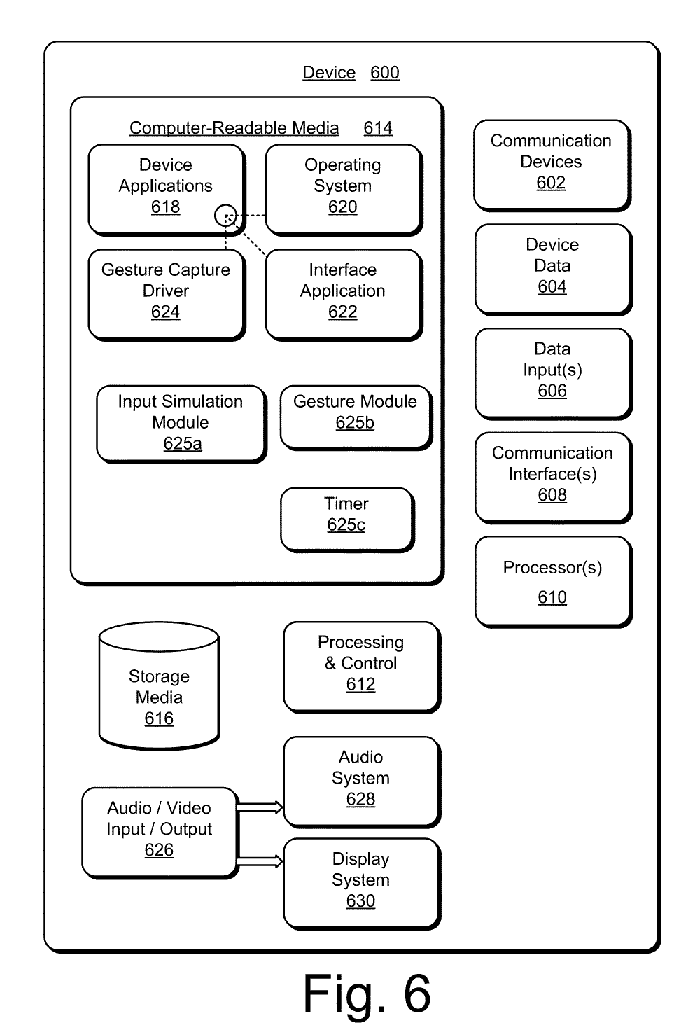

FIG. 6 illustrates various components of an example device 600 that can be implemented as any type of portable and/or computer device as described with reference to FIGS. 1 and 2 to implement embodiments of the animation library described herein. Device 600 includes communication devices 602 that enable wired and/or wireless communication of device data 604 (e.g., received data, data that is being received, data scheduled for broadcast, data packets of the data, etc.). The device data 604 or other device content can include configuration settings of the device, media content stored on the device, and/or information associated with a user of the device. Media content stored on device 600 can include any type of audio, video, and/or image data. Device 600 includes one or more data inputs 606 via which any type of data, media content, and/or inputs can be received, such as user-selectable inputs, messages, music, television media content, recorded video content, and any other type of audio, video, and/or image data received from any content and/or data source.

Device 600 also includes communication interfaces 608 that can be implemented as any one or more of a serial and/or parallel interface, a wireless interface, any type of network interface, a modem, and as any other type of communication interface. The communication interfaces 608 provide a connection and/or communication links between device 600 and a communication network by which other electronic, computing, and communication devices communicate data with device 600.

Device 600 includes one or more processors 610 (e.g., any of microprocessors, controllers, and the like) which process various computer-executable or readable instructions to control the operation of device 600 and to implement the embodiments described above. Alternatively or in addition, device 600 can be implemented with any one or combination of hardware, firmware, or fixed logic circuitry that is implemented in connection with processing and control circuits which are generally identified at 612. Although not shown, device 600 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 600 also includes computer-readable media 614, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 600 can also include a mass storage media device 616.

Computer-readable media 614 provides data storage mechanisms to store the device data 604, as well as various device applications 618 and any other types of information and/or data related to operational aspects of device 600. For example, an operating system 620 can be maintained as a computer application with the computer-readable media 614 and executed on processors 610. The device applications 618 can include a device manager (e.g., a control application, software application, signal processing and control module, code that is native to a particular device, a hardware abstraction layer for a particular device, etc.), as well as other applications that can include, web browsers, image processing applications, communication applications such as instant messaging applications, word processing applications and a variety of other different applications. The device applications 618 also include any system components or modules to implement embodiments of the techniques described herein. In this example, the device applications 618 include an interface application 622 and a gesture-capture driver 624 that are shown as software modules and/or computer applications. The gesture-capture driver 624 is representative of software that is used to provide an interface with a device configured to capture a gesture, such as a touchscreen, track pad, camera, and so on. Alternatively or in addition, the interface application 622 and the gesture-capture driver 624 can be implemented as hardware, software, firmware, or any combination thereof. In addition, computer readable media 614 can include an input simulation module 625a, a gesture module 625b, and a timer 625c that functions as described above.

Device 600 also includes an audio and/or video input-output system 626 that provides audio data to an audio system 628 and/or provides video data to a display system 630. The audio system 628 and/or the display system 630 can include any devices that process, display, and/or otherwise render audio, video, and image data. Video signals and audio signals can be communicated from device 600 to an audio device and/or to a display device via an RF (radio frequency) link, S-video link, composite video link, component video link, DVI (digital video interface), analog audio connection, or other similar communication link. In an embodiment, the audio system 628 and/or the display system 630 are implemented as external components to device 600. Alternatively, the audio system 628 and/or the display system 630 are implemented as integrated components of example device 600.

### CONCLUSION

In the embodiments described above, a timer is utilized in an input simulation process that simulates an input of one type when an input of a different type is received.

In at least some embodiments, when a first type of input is received, a corresponding timer is started. If, before passage of an associated time period, a first input scenario is present, then one or more actions associated with the first input type are performed. If, on the other hand, after passage of the associated time period, a second input scenario is present, then one or more actions associated with a second input type are performed by using the first input type to simulate the second input type.

In at least some other embodiments, when a touch input is received, a corresponding timer is started. If, before passage of an associated time period, the touch input is removed, actions associated with the touch input are performed, e.g., actions associated with a tap input or, actions that are mapped to a mouse input such as an activation or “click”. If, on the other hand, after passage of the associated time, the touch input is removed, actions associated with a mouse input are performed by using the touch input to simulate the mouse input.

Although the embodiments have been described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A method comprising:
receiving input of a first input type;
responsive to receiving the input, starting a timer;
ascertaining that a time period associated with the timer has passed;
after the time period has passed, ascertaining that an input scenario is present;
responsive to ascertaining that the input scenario is present, performing one or more actions associated with a simulated second input type.

2. The method of claim 1, wherein the first input type comprises a touch input.

3. The method of claim 1, wherein the second input type comprises a mouse input.

4. The method of claim 1, wherein ascertaining that the input scenario is present comprises detecting removal of the input.

5. The method of claim 1, wherein ascertaining that the input scenario is present comprises detecting removal of the input, and wherein the first input type comprises a touch input.

6. The method of claim 1, wherein the time period is between 100 ms and 1 second.

7. The method of claim 1, wherein the time period is 300 ms.

8. The method of claim 1, wherein performing one or more actions comprises dispatching at least some script events and omitting at least some other script events effective to persist a CSS hover format that was applied to an element relative to which the input was received.

9. One or more computer readable storage media embodying computer readable instructions which, when executed, implement a method comprising:
receiving a touch input;
responsive to receiving the touch input, starting a timer;
ascertaining that a time period associated with the timer has passed;
after the time period has passed, ascertaining that an input scenario is present; and
responsive to ascertaining that the input scenario is present, performing one or more actions associated with a simulated mouse input.

10. The one or more computer readable storage media of claim 9, wherein ascertaining that the input scenario is present comprises detecting removal of the touch input.

11. The one or more computer readable storage media of claim 9, wherein the time period is between 100 ms and 1 second.

12. The one or more computer readable storage media of claim 9, wherein the time period is 300 ms.

13. The one or more computer readable storage media of claim 9, wherein performing one or more actions comprises dispatching at least some mouse script events and omitting at least some other mouse script events effective to persist a CSS hover format that was applied to an element relative to which the touch input was received.

14. The one or more computer readable storage media of claim 9, wherein performing one or more actions comprises: dispatching at least some mouse script events; omitting at least some other mouse script events; and omitting script events that signal activation of an element.

15. The one or more computer readable storage media of claim 9, wherein the computer readable instructions are further configured to implement a method comprising:
responsive to ascertaining that the time period has not passed and that the touch input has been removed, performing one or more actions associated with the touch input.

16. The one or more computer readable storage media of claim 9, wherein the computer readable instructions reside in the form of a web browser.

17. The one or more computer readable storage media of claim 9, wherein the computer readable instructions reside in the form of an application other than a web browser.

18. A system comprising:
a timer; and
a module configured to use the timer to simulate an input of one type when an input of a different type is received.

19. The system of claim 18, wherein said input of one type comprises a mouse input.

20. The system of claim 18, wherein said input of a different type comprises a touch input.
